(19) United States
(12) Patent Application Publication
(10) Pub. No.: US 2009/0312883 A1
(43) Pub. Date: Dec. 17, 2009

(54) SYSTEM FOR CONTROLLING A POWER, WATER OR GAS SUPPLY

(75) Inventor: Matti Myllymäki, Helsinki (FI)

Correspondence Address: DRINKER BIDDLE & REATH (DC), 1500 K STREET, N.W., SUITE 1100, WASHINGTON, DC, 20005-1209, US

(73) Assignee: Innohome Oy, Helsinki (FI)

(21) Appl. No.: 12/298,272

(22) PCT Filed: Apr. 24, 2007
(86) PCT No.: PCT/FI2007/050220

§ 371 Date: Mar. 4, 2009

(30) Foreign Application Priority Data
Apr. 25, 2006 (FI) 20065263

(51) Int. Cl. G05B 9/02; G06F 1/28

(52) U.S. Cl. 700/293; 700/297

(57) ABSTRACT

The invention relates to a system for controlling a power (6), water (18) or gas (17) supply in emergency and energy saving situations. The system comprises one or more detectors (2, 8, 14, 15, 16) for indicating various service conditions of a monitored space, a control unit (1) as well as a mains-connected fault (7) or overload protector (8) or other control relay for controlling the operating power or water or gas (6, 18, 17) for appliances. The sound of one or more ambient condition monitoring detectors (14, 15, 16) or the presence of persons occupying the space is identified by the control unit's (1) sound defector (2, 3) connected with a monitored or controlled space and on the basis of the alarm sound or the presence of occupants the mains' grounding wire (GND) and neutral wire (N) or the mains' neutral wire (N) and phase lead (L) are actuated to connect with each other by means of a semiconductor switch (4). Alternatively, one or more relays or the fault (7) or overload protector (8) included in power supply are actuated to disconnect or switch on the power supply (6) for a desired site (22).

The invention relates to a system for controlling a power, water or gas supply in emergency and energy saving situations, the system comprising one or more detectors for indicating various service conditions of a monitored space, a control unit as well as a mains-connected fault or overload protector or other control relay for controlling the operating power or water or gas for appliances.

In indemnity costs for buildings, fire and water damages are nearly 100 times higher than expenses resulting from burglaries. Home appliances are responsible for almost 60% of domestic electrical fires and water damages and the consumption of electronic devices in standby mode exceeds the consumption thereof in practical service. What is common for all these aspects is that most of the electrical and gas fires and water damages, as well as the energy consumption in standby mode could be eliminated by controlling the supply of power, water and gas.

The use of a fault current protector for disconnecting electric power has been described in publication FI 05861 B, wherein the fault current protector is controlled by a smoke alarm through a supplementary relay, and in publication DK29393, wherein e.g. a gas detector is used for a controlled disconnection of electric power by means of a fault current protector to avoid arcing. Prior known control solutions for a gas, water and power supply include centralized security and building automation systems, wherein the detectors are set in communication with a central processing unit which in turn controls power, water and gas supply with its actuators. A third prior known solution comprises appliance-specific intermediate socket-outlets, which observe the ambience and the status of appliances connected thereto, as well as control the power, water and gas supply, as required by various occasions.

A problem here is that all of the foregoing solutions are only designed to cover a few aspects of the described building requirements, whereby every solution calls for separate equipment. The commercially available solutions are not feasible for minimizing the standby mode energy consumption of electrical appliances, the purchase prices of applicable equipment being at such a high level that the achieved savings do not cover the acquisition investments.

A problem with the solution described in publication FI 05861 B is that the solution requires the installation of a permanent wire in existing buildings from an alarm detector to a fault current protector, the appliances to be protected being often in phases different from each other. The installation of an extra wire results either in aesthetic drawbacks and/or significant extra costs. Consequently, the solution is principally useful in new buildings, but poorly feasible for existing sites. A problem with the solution described in publication DK29393 is that while arcing is eliminated, gas leakage is not and thereby just one problem has been resolved. In both of the foregoing prior art solutions, the control of an electrical network is implemented by using a relay which is only suitable for controlling a fault current protector.

A problem with fire and plumbing protection systems is that the systems call for purpose-built detectors, which require either permanent wiring or detector-specific data transmission, making the equipment pricey. The appliance-specific safety solutions require that every appliance be provided with separate protection devices, which also makes the solution pricey.

It is an object of the invention to provide a system, enabling elimination of the above problems and in such a beneficial manner that the system is also useful for reducing the standby mode energy consumption of home appliances. A novel feature in the solution is the fact that a single common control device is capable of handling both emergency situations and energy saving. The control device also recognizes automatically when a monitored space is occupied and is able to control simultaneously all pieces of equipment within the scope of protection as well as energy saving, primarily by analyzing ambient sounds. The sound analyses can be used for identifying alarm sounds of alarm detectors, as well as movement of persons in and out the doors of a site and normal sound signals created by people. The solution according to the invention enables the use of economical standard alarm detectors for indicating various emergency situations, enabling as well a detection of the opening and closing of doors without door-mounted sensors. An infrasonic sensor, accompanied by an identification of normal sounds, enables a reliable detection about when a space is occupied and when a space is indeed vacated. Another novelty in the solution is a control of power supply, based on fault or overload protection or separate data transmission, without extra cabling. The economical battery-operated detectors can also be more conveniently placed in an optimal position without restrictive cabling. By means of a single, easy-to-fit accessory, the solution according to the invention enables an identification of smoke, gas and water leakage incidents with economical standard detectors, as well as a protection against such incidents without extra cabling, as well as a minimization of energy consumption in both standby mode and heating.

The solution is based on a mains- or battery-operated accessory, which covers all the above demands and which is connectable to a common socket-outlet or a space to be monitored. The accessory identifies the alarm sounds of alarm detectors and additionally when there is a presence in the site and applies this information to control a water, power and gas supply both in alarm and energy saving conditions. The control of an electrical network or the data transmission is effected by means of an electronic switch, which directly instructs a desired fault or overload protector or a relay to disconnect electric power from a relevant socket-outlet or from outlets included in one safety circuit by making use of existing electrical cabling or other prior known communication. If the building has already installed therein appropriate fault or overload protectors and smoke detectors, the remodelling and installation operations will be totally avoided in the process of setting up the alarm controls. Thus, in the event of using just alarm detectors, it will be sufficient that a simple accessory be connected to a socket-outlet.

The solution also simplifies gas and water leakage protection since, in addition to an accessory that identifies alarm sounds, all that is needed are solenoid valves whose control is obtained directly from an electrical network. Hence, in an alarm situation, the disconnection of power supply cuts off also water and gas, thus preventing collateral damage. Most dish washing machines already include the Aqua Stop feature as a standard function, wherein the disconnection of electricity shuts off the supply of water, the only required procedure in this case being the installation of an accessory in a socket-outlet and the installation of a leak detector underneath the washing machine.

A common accessory may also control automatically the power, gas and water supply for home appliances, such that the supplies are disconnected whenever a monitored space is vacant. This serves to minimize electrical fires, water spillages and gas leaks caused by home appliances, as well as the energy consumption in standby mode. The minimization of standby mode energy consumption will be also economically viable, the price of a common accessory being graded among many applications. In addition, one and the same controller can also be used for a heating control.

The invention will now be described in more detail with reference to the accompanying drawings, in which:

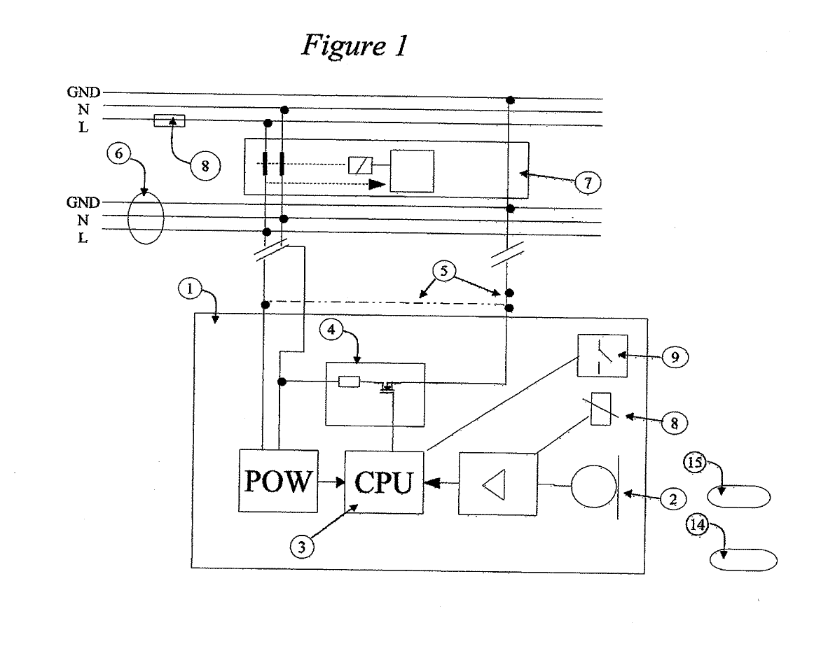

FIG. 1 shows a structural block diagram for an accessory included in a system of the invention and its connection with an electrical network,

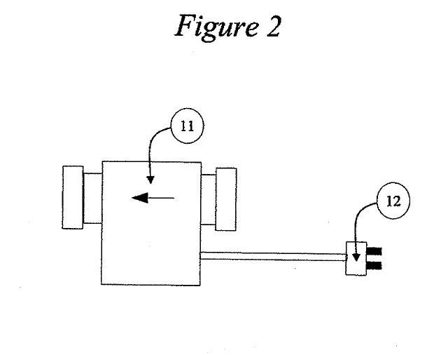

FIG. 2 shows the mechanical construction of an accessory of the invention intended for a gas and water control,

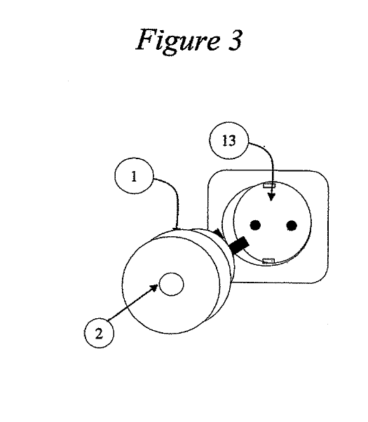

FIG. 3 shows the mechanical construction of an accessory of the invention, and

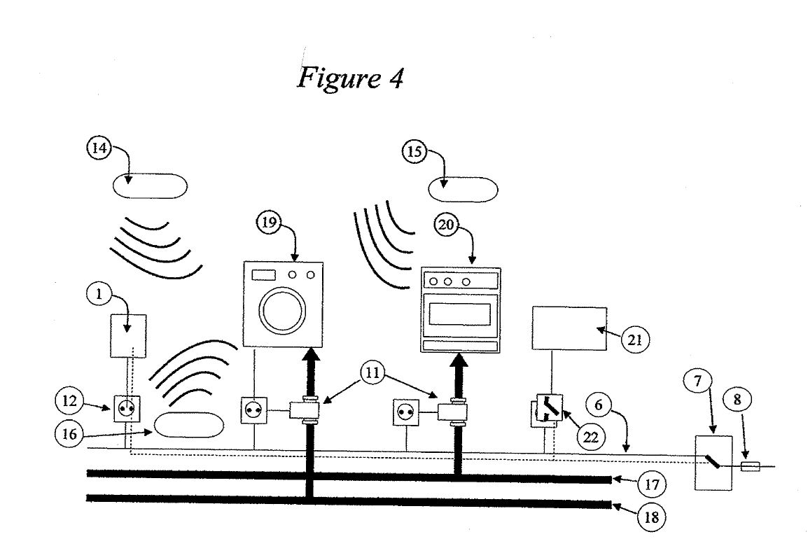

FIG. 4 shows a system of the invention implemented with the accessory.

Referring to FIG. 1, there is shown an accessory 1 in block diagram and its direct connection 5 with an electrical network 6. The control relay, which identifies a control message, can be a fault current protector 7 and/or an overload protector 8. The accessory 1 includes a microphone 2, which listens for ambient alarm detectors and infrasounds, as well as a temperature sensor 8 to measure ambient temperature. The accessory's microprocessor 3 analyzes the sounds as well as temperature and controls a semiconductor switch 4 used for communication. When the microprocessor 3, by means of the microphone 2, identifies the alarm sound of a smoke or gas detector, it closes the semiconductor switch 4 which short-circuits (being connected to the dashed-line wire 5) a phase lead L and a neutral wire N, the overload protector 8 tripping and thereby disconnecting the supply of power. Alternatively, the semiconductor switch 4 short-circuits (being connected to a continuous-line wire, as shown in FIG. 1) the neutral wire N and a grounding wire GND, the fault current protector 7 tripping and thereby disconnecting the supply of power. In this case, the only way of restoring the power supply is to operate manually either the overload protector or the fault circuit protector to re-establish the supply. A control message can also be transmitted from the accessory by means of a semiconductor switch as an electrical message, for example by way of a carrier-wave link making use of an electrical network, whereby the supply can be both disconnected and switched on by means of the fault current protector 7. This feature can be used for saving energy, the temperature sensor 8 included in the accessory being used for controlling the heating of a room space in such a way that the detection of infra- and normal sounds by the microphone 2 is applied for verifying when the monitored space is vacated. The supply for heating equipment or air conditioning is controlled by the relay 7, such that the temperature of a room can be dropped by disconnecting electrical power from heating supply and by switching on the heating for the space by means of the accessory's 1 temperature sensor 8 only when temperature falls below a desired minimum. When the space becomes occupied again, the electric power is switched on continuously, the heating being controlled by thermostats included in heaters and an air conditioner. The same solution can also be used for minimizing the power consumption of electrical appliances in standby mode with no one present in the monitored space. A control relay 9 included in the accessory can also be used for controlling directly an existing thermostat.

Referring to FIG. 2, there is shown a solenoid or motor-driven valve 11 used in the invention for switching on a water or gas supply when a power supply 12 is already on. The valve 11 is based on a mains-supply controlled solenoid or motor-driven valve, which is open whenever it has the service power 12 on and closed whenever the power supply 12 is off. In the case of a motor-driven valve 11, the valve set can be adapted to include a battery from which the valve takes its operating power whenever the power supply is disconnected.

Referring to FIG. 3, there is shown the simplest mechanical design for an accessory 1. Electronics 2, 3, 4 housed in the accessory is accommodated in a simple socket plug 1, all that is required therein being an opening for the microphone 2 for sound monitoring. The plug is readily insertable in a standard socket-outlet 12.

Referring to FIG. 4, there is shown a disposition of the accessory 1 in a monitored space and ambient alarm sensors relevant thereto, such as a smoke detector 14, a gas detector 15 or a leak detector 16, as well as controlled appliances, such as a washing machine 19, a gas range 20, and a heating radiator 21. In the monitored space, the accessory 1 is connected to the same phase 6 as the controlled appliances 19, 20, 21. Once an alarm is set off by any of the ambient sensors, the smoke/carbon monoxide detector 14 or the gas detector 15 or the water leakage detector 16, the accessory 1 actuates a disconnection of power supply by means of a switching unit 7 or 8 or 21 from appliances connected to the same phase. When a saving in heating is desired, the heating radiator 21 is controlled by the accessory's 1 temperature sensor 8, such that the temperature of a space is dropped whenever the space is unoccupied by disconnecting the electric power from the heating radiator by means of an intermediate socket-outlet 22 and by holding the temperature as desired under the control of the accessory 1. The controlled appliance may also be some other device, the energy consumption of which should be reduced. The communication can be established by means of any prior known data transmission protocol, such as a mains modem. At the same time as the power supply disconnects, the solenoid valves 9 of the washing machine 19 and the gas range 20 are opened, thus disconnecting a water supply 18 and a gas supply 17.

In the case of FIG. 4, the control unit 1 is built in a plug 1 insertable in any socket-outlet 11, one or more control units 1 being in communication with the device 7, 8 which connects and/or disconnects regional power supply.

The invention is characterized by the ability of a single control unit 1 to disconnect a water, gas and power supply by means of an alarm received from standard alarm detectors in a wireless manner.

1. A system for controlling a power, water or gas supply in emergency and energy saving situations, the system comprising one or more detectors for indicating various service conditions of a monitored space, a control unit as well as a mains-connected fault or overload protector or other control relay for controlling the operating power or water or gas for appliances, wherein the sound of one or more ambient condition monitoring detectors or the presence of persons occupying the space is identified by the control unit's sound detector connected with a monitored or controlled space and on the basis of the alarm sound or the presence of occupants the mains' grounding wire and neutral wire or the mains' neutral wire and phase lead (L) are either actuated to interconnect by means of a switch or one or more relays or the fault or overload protector included in power supply are actuated to disconnect or switch on the power supply for a desired site or area.

2. A system as set forth in claim 1, wherein the system is adapted to control solenoid or motor-driven valves for a gas or water supply.

3. A system as set forth in claim, wherein water leakage is adapted to be detected also by means of a wired sensor.

4. A system as set forth in claim 1, wherein the system is used as an automatically activated and inactivated long-term timer, which switches on electric power upon opening the door of a site or upon sensing a sound/movement within the site and switches off electric power after a given time has lapsed since the latest opening of the door and/or the sound/movement.

5. A system as set forth in claim 1, wherein the occupancy of a site is also adapted to be identified by using an infrared detector alone or together with sound identification.

6. A system as set forth in claim 1, wherein the control unit is built in a plug insertable in any socket-outlet, one or more control units being in communication with the device which connects and/or disconnects regional power supply.
